(19) United States
(12) Patent Application Publication
(10) Pub. No.: US 2005/0044979 A1
(43) Pub. Date: Mar. 3, 2005

(54) Park pawl actuator

(76) Inventors: William H. Fort, Stratham, NH (US); Knight Ko, Quincy, MA (US); William Farmer, Acton, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/601,077

(22) Filed: Jun. 20, 2003

Related U.S. Application Data
(60) Provisional application No. 60/390,084, filed on Jun. 20, 2002.

(51) Int. Cl. G05G 5/00

(52) U.S. Cl. 74/473.21

(57) ABSTRACT

An electromechanical actuator for locking a detent bracket in an out of park position is provided. The actuator includes a latching lever that is moveable between a first position and a second position. When the latching lever is in the first position and the solenoid is in an extended position the plunger of the solenoid is positioned between a bearing surface of the latching lever and a bearing surface on a base plate, thereby preventing the latching lever from pivoting to the second position. A park pawl actuator including a rack coupled to park pawl and a motor for driving the rack is also provided.

### CROSS-REFERENCE TO RELATED APPLICATIONS

This application claims the benefit of U.S. provisional patent application Ser. No. 60/390,084, filed Jun. 20, 2002, the entire disclosure of which is incorporated by reference.

### FIELD OF THE INVENTION

The present invention relates in general to a system for controlling the gear position of an automotive transmission, and, more particularly, to a park pawl actuator for controlling park pawl position in an automotive transmission.

### BACKGROUND OF THE INVENTION

Automatic transmission gear selection may be controlled by a combination of mechanisms, e.g. hydraulic valves and electronics. In most transmissions, the operator selects Park—P, Reverse—R, Neutral—N, or Drive—D. Also, in the Drive mode the operator has the choice of selecting D which allows the transmission to shift ‘automatically’ through the Drive range, or the operator can select one of the lower range Drive modes which are designated by Low—L or D1 through D3, D4; D5 or D6 depending on the transmission.

It is common, when shifting from Park to Reverse or Drive that a mechanical link connects the driver input to mechanical hydraulic valves. Electromechanical hydraulic valves control the different Drive range states. In both the Park and Neutral states, typically no hydraulic valves are engaged. In Neutral, nothing is engaged and the transmission output shaft is uncoupled from any input. In the Park state, a mechanical element, often called the park pawl restricts rotation of the output shaft. When the operator puts the shifter into the park position, the mechanical linkage engages the park pawl.

According to a new approach to transmission gear selection, all shifting operations are achieved with electronic control. Engaging Reverse and the Drive gears is easily done using electromechanical valves. Engaging Park and Neutral may also be accomplished using a hydraulic piston controlled by electromechanical valves. However, with this approach one cannot shift in and out of park with the engine off because hydraulic pressure is generated only when the engine is running.

Accordingly, there is a need in the art for an efficient and reliable park pawl actuator for controlling the gear position of an automotive transmission.

### SUMMARY OF THE INVENTION

According to a first aspect, an electromechanical actuator is provided including a latching lever pivotable between at least a first position and a second position, the latching lever including a bearing surface; a stationary bearing surface; and a solenoid including a plunger moveable between an extended position and a retracted position, wherein when the lever is in the first position and the plunger is in the extended position the plunger is disposed between the lever bearing surface and the stationary bearing surface thereby blocking the lever from pivoting to the second position, and when the plunger is in the retracted position the lever is not blocked from pivoting between the first and second positions.

According to another aspect, an actuator is provided comprising a base plate; a lever pivotally disposed on the base plate, the lever including a lever roller, the lever being pivotal between at least a first position and a second position; a stationary roller disposed on the base plate, the stationary roller proximate to the lever roller when the lever is in the first position; and a solenoid including a plunger moveable between an extended position and a retracted position, wherein the plunger is disposed between the lever roller and the stationary roller when the lever is in the first position and the plunger is in the extended position, thereby preventing the lever form pivoting to the second position.

According to yet another aspect, the present invention is an electromechanical park pawl actuator including a motor, a gear train driven by the motor, and an output, rack adapted to be driven by the gear train between at least a first and a second position. The output rack is coupled to a park pawl whereby the park pawl is in a park position when said output rack is in the first position and the park pawl is in an out of park position when the output rack is in the second position.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is an exploded view of an exemplary embodiment of a park pawl actuator consistent with the present invention;

FIG. 2 is a perspective view of the exemplary actuator illustrated in FIG. 1;

FIG. 3 is a perspective view of the exemplary actuator illustrated in FIG. 1, showing first and second positions for the illustrated latching lever;

FIG. 4 is an exploded view of another exemplary embodiment of a park pawl actuator consistent with the present invention;

FIG. 5 is a perspective view of the exemplary actuator illustrated in FIG. 4;

FIG. 6 is a perspective view of the exemplary actuator illustrated in FIG. 4, showing first and second positions for the illustrated latching lever;

FIG. 7 is a perspective view of another exemplary embodiment of a park pawl actuator consistent with the present invention;

FIG. 8 is a front perspective view of an exemplary electromechanical actuator for a park pawl engagement consistent with the present invention;

FIG. 9 is a rear perspective view of the exemplary electromechanical actuator of FIG. 8; and

FIG. 10 shows the exemplary electromechanical actuator of FIG. 8 in a front elevation view.

### DETAILED DESCRIPTION

The present invention is described herein in the context of a pawl actuator included in an automatic transmission selector system. The operation of an actuator consistent with the present invention is described by way of exemplary embodiments thereof. It is to be understood, however, that the illustrated embodiments are provided only by way of illustration, not of limitation. While the invention is described in the context of pawl actuator for an automatic transmission system, it will be appreciated that the actuator may be suitable for other applications requiring a latching mechanism.

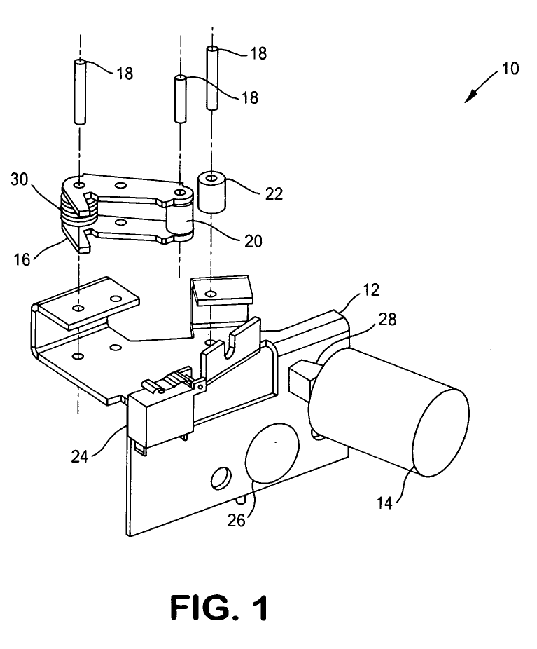

Turning to FIG. 1, an exemplary pawl actuator 10 consistent with the present invention is shown in an exploded view. The illustrated actuator generally includes a base plate 12 having a solenoid 14 and latching lever 16 mounted thereon. The latching lever 16 may be pivotally mounted to the base plate 12 by a pin 18, and adapted to follow a detent bracket (not shown) of the gear selector for a transmission system. Additionally, the actuator may include one or more sensors or switches, such as the mechanical switch 24 and the pressure switch 26, that may be used for indicating the configuration of the actuator, i.e., “park” or “out of park”, etc.

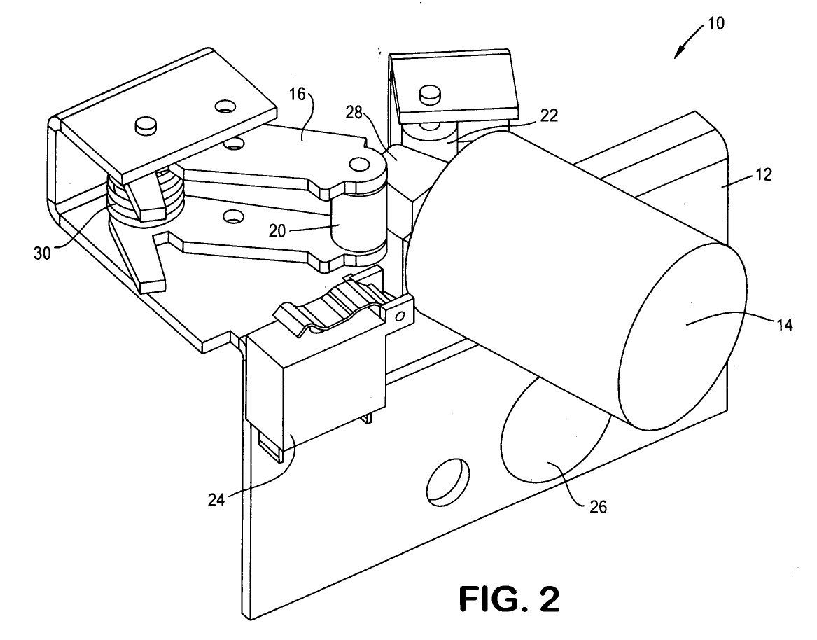

Referring to FIG. 2, the assembled actuator 10 is shown in a first “out of park” configuration. In the “out of park” configuration rollers 20 and 22, respectively disposed on a free end of the latching lever 16 and the base plate 12 are positioned in an opposed arrangement. The solenoid 14 is energized to extend the plunger 28 between the opposed rollers 20, 22. The presence of the plunger 28 between the rollers 20, 22 locks the latching lever 16 against pivoting in a counterclockwise direction to a “park” configuration. However, as can be seen in the illustration, the solenoid 14 does not itself resist the motion of the latching lever 16. Rather, the solenoid 14 extends to position the plunger 28 such that when the lever 16 rotates counterclockwise the plunger 28 is compressed between the lever roller 20 and the stationary roller 22. This may allow a relatively low power solenoid to lock the latching lever 16 against a high load.

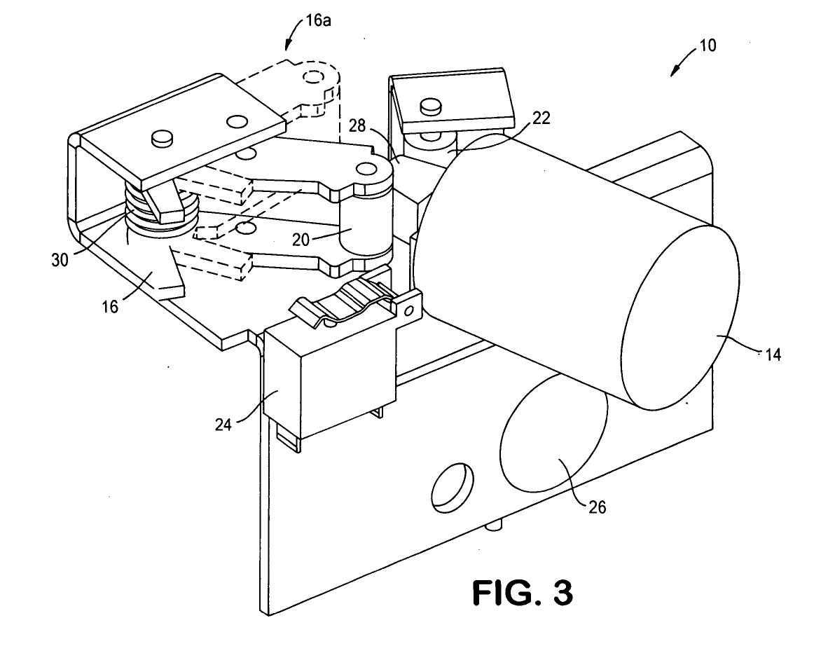

In operation, when the detent bracket of the gear selector is in “Park”, the latching lever 16 is in a free stay, or “out of park” position as shown in broken lines in FIG. 3. In this position the solenoid 14 may be in a retracted position, and the mechanical switch 24 may be closed to indicate that the system is in “park”. When the gear selector is shifted to a gear other than “park”, a torsion spring 30 which biases the latching lever 16 toward an “out of park” position (shown in solid lines in FIG. 3) will push the latching lever 16 to follow the detent bracket. Also as the detent bracket is moved out of the “park” position, the mechanical switch may be opened, thereby alerting the system of the “out of park” condition. Once the latching lever 16 has followed the detent bracket to a full “out of park” position, the solenoid may be energized to extend the plunger 28 between the opposed rollers 20 and 22. Once the plunger 28 is between the rollers 20, 22 the latching lever 16 is locked against rotation in a counterclockwise direction (in the embodiment and view of FIGS. 1 through 3) until the solenoid 14 is retracted. This in turn may prevent the movement of the detent bracket from an “out of park” position to the “park” position.

In the above embodiment, the solenoid 14 may be biased toward a retracted configuration, e.g., by a spring that is compressed when the solenoid 14 is energized and the plunger 28 is extended. When the actuator 10 is in the “out of park” position and the solenoid 14 is not energized, for example when the vehicle loses electrical and/or hydraulic power, the biasing element causes the plunger 28 to retract, thereby unlocking the latching lever 16 against counterclockwise movement. This may allow the detent bracket: of the shifter to be returned to the “park” position.

The ability of the actuator 10 to unlock when the solenoid 14 is not energized may be, in part, facilitated by positioning the extended plunger 28 between the opposed rollers 20, 22. The rolling action of the rollers 20, 22 as the plunger 28 is retracted may reduce drag and resistance to retraction, thereby allowing the plunger 28 to be retracted with a relatively small force. Providing the plunger 28 having a tapered or wedge shaped may also reduce the force necessary to retract the plunger 28 from between the rollers 20, 22. A wedge shape may allow the lever 16 to begin rotating in a counterclockwise direction during the retraction of the plunger.

Following from the concept of providing a wedge shaped plunger, the plunger may additionally be provided having a tapered distal region, and an un-tapered proximal region. Accordingly, when the plunger is in a fully extended position the opposed rollers are in contact with the un-tapered region of the plunger. As the plunger is retracted the rollers may enter the tapered distal region, therein reducing the necessary extraction force. It should be understood that such a configuration is not necessary. Additionally, it may be possible to achieve a similar effect by providing appropriate relative contacts angles between the rollers and the plunger, as will be understood by those having skill in the art.

As an alternative to one of both of the rollers 20, 22, the opposed bearing surfaces may be used to achieve the locking and unlocking effect of the actuator. When one or both of the rollers are replaced by a bearing surface, the force required to retract the plunger may be reduced by providing the bearing surfaces having a smooth surface, thereby reducing friction and/or drag. Additionally, drag from retracting the plunger may be reduced by providing the bearing surfaces having an angled or rounded shape.

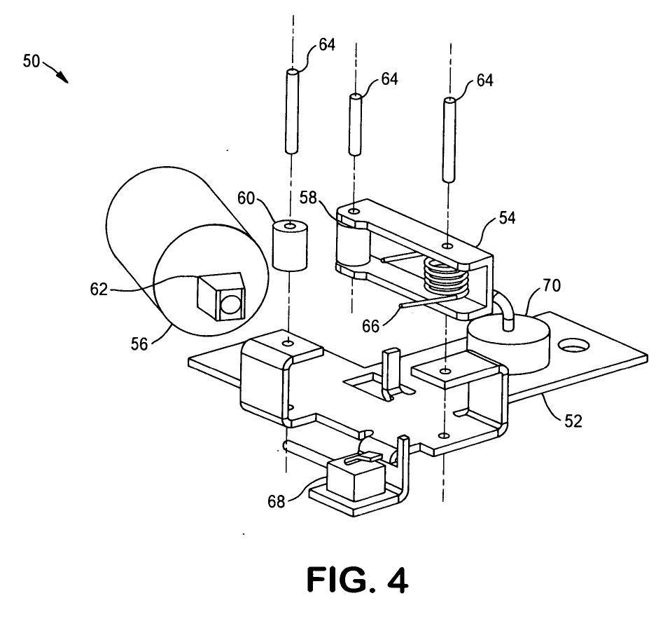

Turning to FIGS. 4 through 6, a second exemplary actuator 50 positionable in a “park” and “out of park” configuration is illustrated. With reference to FIG. 4, an exploded view of the second actuator 50 is shown including the same general components as the previous embodiment. The actuator includes a base plate 52 having a latching lever 54 and solenoid 56 mounted thereon. One end of the latching lever 54 is pivotally mounted on the base plate 52, and the other end of the lever 54 includes a roller 58. An opposed roller 60 is mounted on the base plate 52. The rollers 58 and 60, as well as the lever 54 may be mounted on pins 64, etc. to provide pivotal and/or rotational movement.

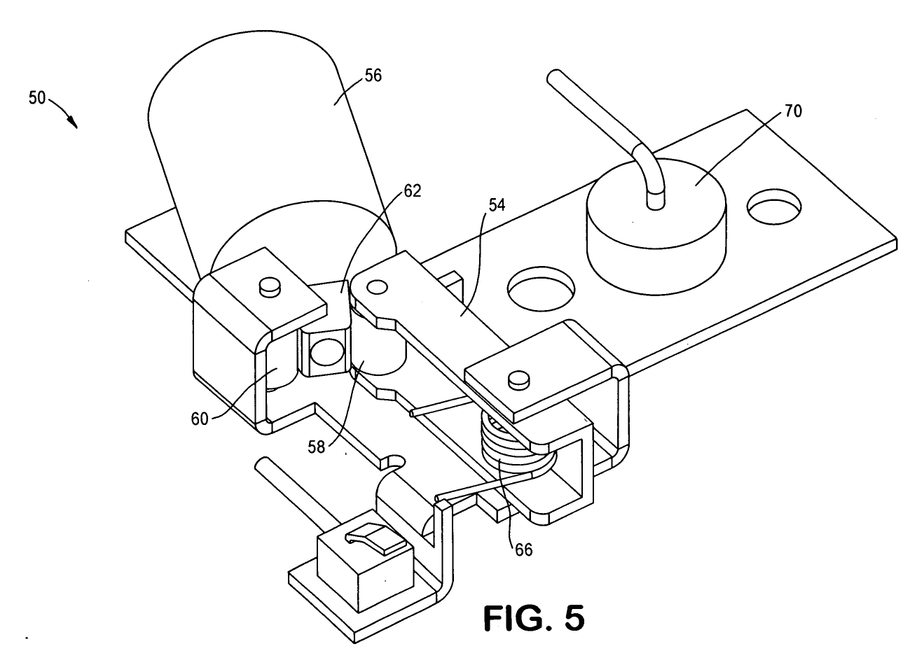

Similar to the first embodiment, the solenoid 56 includes a plunger 62 that is moveable between an extended position, in which the plunger 62 may restrict movement of the lever 54 to the “park” position, and a retracted position that may allow such movement of the lever 54. FIG. 5 illustrates the actuator 50 in the “out of park” configuration. As shown, the plunger 62 is in an extended position between the opposed rollers 58, 60. The presence of the plunger 62 blocks pivotal movement of the latching lever 54 in a counterclockwise direction toward the “park” configuration.

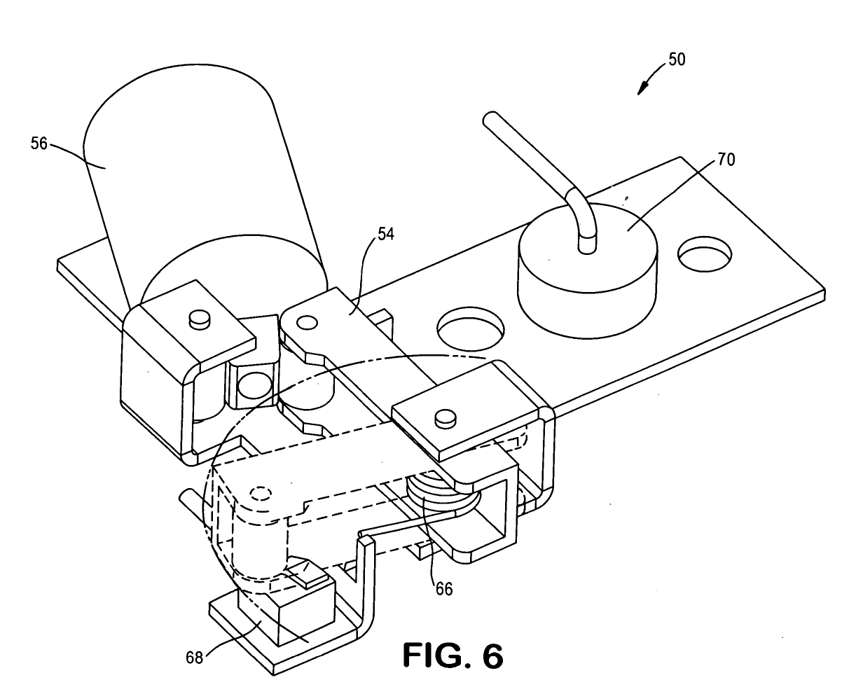

Referring to FIG. 6, the second exemplary actuator 50 is illustrated with the latching lever 54 in both the “out of park” configuration (solid lines) and the “park” configuration (broken lines). As shown, the actuator 50 may include a spring 66, or other biasing element, to bias the latching lever 54 toward the “out of park” configuration. As with the first embodiment, the biasing spring 66 may allow the latching lever to follow the detent bracket as the gear selector is shifted from a “park” to an “out of park” position. When the latching lever 54 is in the “park” configuration the lever 54 may actuate mechanical switch 68 to provide an indication that the system is in “park”.

Operation of the second exemplary actuator 50 is similar to the operation of the first actuator. Referring to FIG. 6, when the latching lever 54 is in a “park” position, e.g., when the detent bracket is in the “park” position (shown in broken lines), the lever 54 may close mechanical switch 68 to indicate the “park” position to associated systems. Additionally, when the lever 54 is in the “park” position the torsion spring 66 is in a preloaded or tensed state. When the detent bracket is moved from the “park” position torsion spring 66 may urge the lever 54 to follow the detent bracket out of the “park” position, thereby releasing the mechanical switch 68 and indicating the changed position. Once the latching lever 54 has rotated to an “out of park” position, as shown in solid lines in FIG. 6, the solenoid 56 may be energized. When the solenoid is energized the plunger 62 may be in an extended position between the rollers 58, 60 preventing the lever 54 from pivoting back to the “park” position.

Also, as with the previous embodiment, the solenoid 56 may be biased, as by a compression spring, etc., to retract the plunger 62 when the solenoid 56 in not energized. Accordingly, if the actuator 50 loses electrical power or a loss of hydraulic pressure is detected by sensor 70, the solenoid 56 may not be energized and the plunger 62 will assume a retracted position unlocking the latching lever 54 allowing counterclockwise rotation, i.e., to a “park” position.

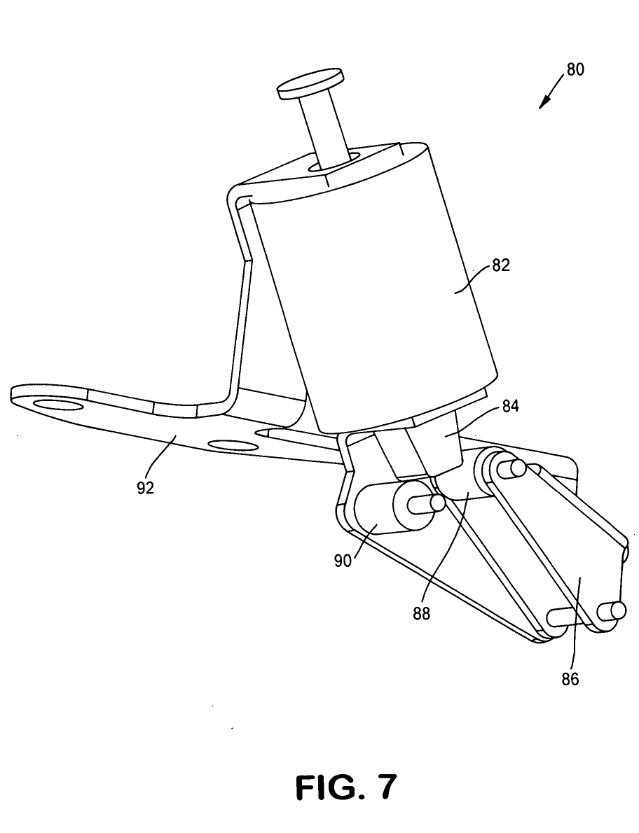

Referring to FIG. 7, another exemplary actuator 80 is illustrated. Similar to the previously described embodiments, the actuator 80 includes a solenoid 82 having a plunger 84. The plunger 84 is moveable between a retracted position (as shown) allowing a latching lever 86 to pivot in a counterclockwise direction. Alternatively, the plunger 84 may be extended such that it may be disposed between a roller 88 on the lever 86 and a roller 90 disposed on a base plate 92. When the plunger 84 is extended between the rollers 88, 90 the lever is prevented from pivoting in a counterclockwise direction.

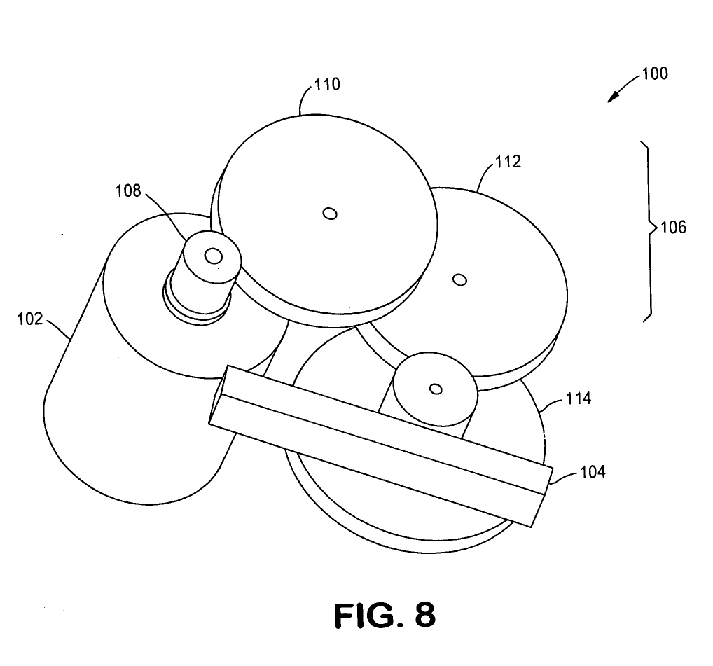

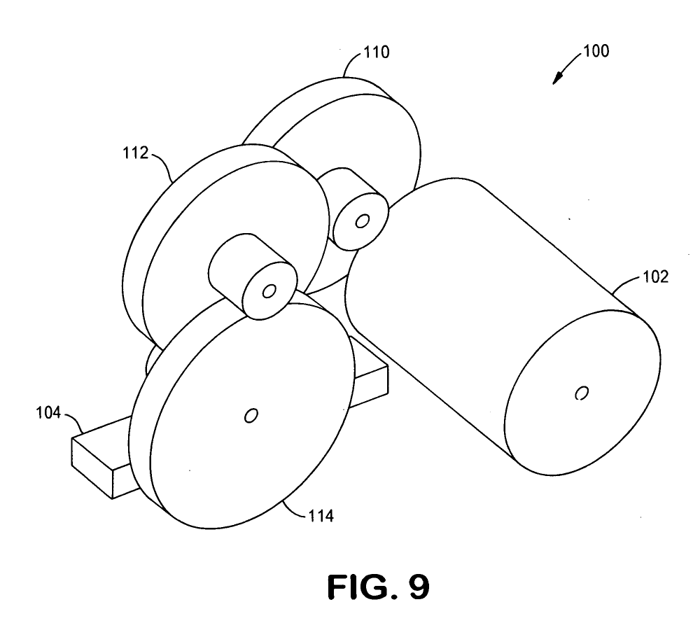

Turning to FIGS. 8 through 10, an exemplary electromechanical actuator 100 that may be used in conjunction with the preceding actuator in a park pawl system consistent with the present invention is illustrated. The electromechanical actuator includes a motor 102 that drives an output rack 104 through a gear train 106, generally. The gear train 106 may include a plurality of simple and/or compound gear elements to provide the necessary driving force to the rack 104, as well as placing the rack in the desired location and orientation relative to the motor 102. Those having skill in the art will appreciate that numerous gear train variations are available. In the illustrated embodiment, the motor 102 includes a pinion 108 driving a first compound driven element 110. The first element 110 in turn may drive a second compound gear 112, which drives a third element 114. In the illustrated exemplary embodiment, the third element 114 drives the output rack 104.

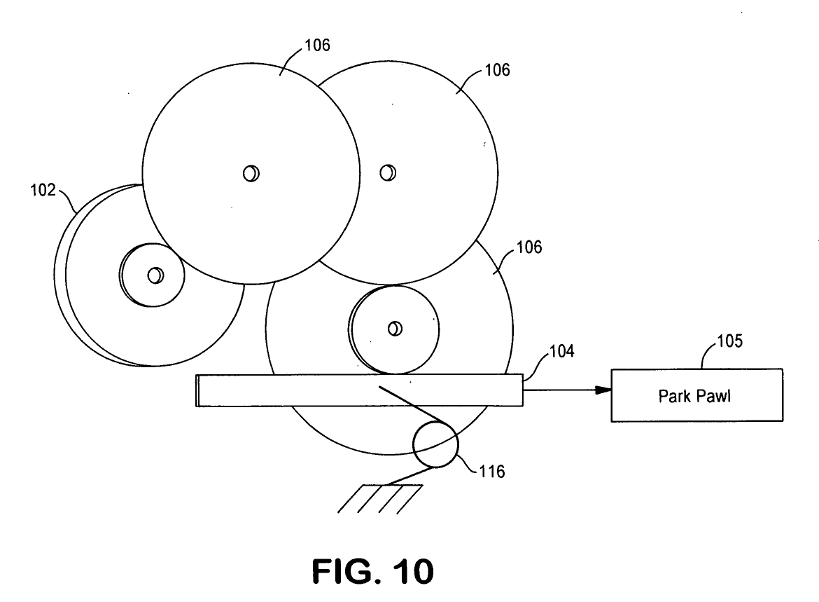

The output rack 104 may be coupled to a park pawl 105, as schematically represented in FIG. 10. To engage “Park” the motor 102 is energized to drive the rack 104 to a first position. Similarly, “Park” may be disengaged by driving the rack to a second position. Consistent with one exemplary embodiment, the first position and second position may be at opposite ends of travel for the rack. Driving the rack 104 between the first position and second position may be achieved by driving the motor 102 for a predetermined period of time to ensure that the rack 104 reaches the desired position. Additionally, or alternatively, limit switches, position sensors/switches torque sensors, etc. may be used to ensure that the output rack 104 has been driven to the desired position.

The actuator may also include a clutch or other over-drive protection system as is known in the art. The clutch or similar over-drive protection may be useful when the rack is driven for a predetermined time period. This may reduce the possibility of damage to the rack or gear train in the event that movement of the rack is inhibited for a portion of the driven time.

The system may be provided having only the two states: “park” and “out of park”, i.e., “Park” engaged or disengaged. As shown in FIG. 10, the output rack 104 may include an over center spring 116. The use of an over center spring 116 may achieve a number of design objectives at a very low cost because the over center spring 116 will keep the output rack 104 in one of the first position and the second position when the motor 102 is not energized.

As a first aspect of this feature, the over center spring 116 may aid in keeping the system in either the “park” or “out of park” state when the motor 102 is not energized. Maintaining the system in the “park” or “out of park” state may be accomplished without the use of active controls. The over center spring 116 may bias the output rack 104 toward the closer of the first position and the second position. That is, if the output rack 104 is in the first position the over center spring 116 will bias the output rack 104 toward the first position, thereby aiding the system in maintaining the state associated with the first position.

Second, the biasing effect of the over center spring 116 may also provide a failsafe in the event of an electrical failure. Because the over center spring may bias the output rack 104 toward the closer of the first position and the second position? if the electrical system faults in mid-travel between the first and second positions, the over center spring will drive the output rack 104 toward the closest position. Therefore, consistent with this aspect of the invention, the system may not be stuck partially engaged or disengaged. The system will either be in “Park” or “out of park”.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

1. An actuator comprising:
a latching lever pivotable between at least a first position and a section position, said lever comprising a lever bearing surface;
a stationary bearing surface; and
a solenoid comprising a plunger moveable between an extended position and a retracted position, wherein when said lever is disposed in said first position and said plunger is in said extended position said plunger is disposed between said lever bearing surface and said stationary bearing surface thereby blocking said lever from pivoting to said second position, and when said plunger is in said retracted position said lever is not blocked from pivoting between said first position and said second position.

2. The actuator of claim 1 wherein at least one of said leaver bearing surface and said stationary bearing surface comprises a roller.

3. The actuator of claim 1 wherein said lever is biased toward one of said first position and second position.

4. The actuator of claim 3 wherein said lever is biased toward said first position by a torsion spring.

5. The actuator of claim 1 wherein said plunger is biased toward one of said extended position and said retracted position when said solenoid is in an un-energized state.

6. The actuator of claim 5 wherein said plunger is biased toward said retracted position by a compression spring when said solenoid is in said un-energized state.

7. The actuator of claim 1 further comprising a mechanical switch that is closed when said lever is in one of said first position and said second position.

8. The actuator of claim 1 wherein said plunger is wedge shaped.

9. An actuator comprising:
a base plate;
a lever pivotally disposed on said base plate, said lever comprising a lever roller, and said lever being pivotable between a first position and a second position;
a stationary roller disposed on said base plate, said stationary roller proximate to said lever roller when said lever is in said first position;
a solenoid comprising a plunger moveable between an extended position and a retracted position, wherein said plunger is disposed between said lever roller and said stationary roller when said plunger is in said extended position and said lever is in said first position, thereby preventing said lever from pivoting to said second position.

10. The actuator according to claim 9 further comprising a torsion spring biasing said lever toward said first position.

11. The actuator according to claim 9 further comprising a compression spring biasing said plunger toward said retracted position when said solenoid is in an un-energized state.

12. The actuator according to claim 9 further comprising a mechanical switch that is closed when said lever is in said second position.

13. The actuator according to claim 9 wherein said plunger is wedge shaped.

14. A method of locking a detent bracket in an out of park position comprising
providing an actuator comprising a latching lever comprising a lever bearing surface, said latching lever pivotable between at least a first position and a section position; a stationary bearing surface; and a solenoid comprising a plunger moveable between an extended position and a retracted position;
providing a detent bracket adjacent said latching lever, said detent bracket moveable between a park position when said latching lever is in said second position and an out of park position when said latching lever is in said first position;
positioning said detent bracket in said out of park position;
positioning said latching lever in said first position; and
extending said plunder between said lever bearing surface and said stationary bearing surface thereby blocking said lever from pivoting to said second position, thereby locking said detent bracket from moving to said out of park position.

15. The method according to claim 14 wherein at least one of said leaver bearing surface and said stationary bearing surface comprises a roller.

16. The method according to claim. 14 wherein said latching lever is biased toward said first position by a torsion spring.

17. The method according to claim 14 wherein said plunger is biased toward said retracted position by a compression spring when said solenoid is in an un-energized state.

18. The method according to claim 14 wherein said plunger is wedge shaped.

19. The method according to claim 16 wherein said detent bracket is in a leading position relative to said latching lever whereby said torsion spring caused said latching lever to follow said detent bracket when said detent bracket is moved from said park position to said out of park position.

20. The method according to claim 14 wherein extending said plunger comprises energizing said solenoid.

21. An electromechanical park pawl actuator comprising:
a motor;
a gear train driven by said motor; and
an output rack adapted to be driven by said gear train between at least a first and a second position;
wherein said output rack is coupled to a park pawl whereby said park pawl is in a park position when said output rack is in said first position and said park pawl is in an out of park position when said output rack is in said second position.

22. The actuator according to claim 21 further comprising an over center spring configured to bias said output rack toward a closer of the first position and the second position.
